(19) United States
(12) Patent Application Publication
(10) Pub. No.: US 2020/0060108 A1
(43) Pub. Date: Feb. 27, 2020

(54) INDOOR PROCESS AND SYSTEM FOR CULTIVATING AND HARVESTING DUCKWEED

(71) Applicant: Energy Management Concepts, Inc., Carlisle, PA (US)

(72) Inventors: Rhett GOLDSMITH, Carlisle, PA (US); Jon BELLOWS, Greensburg, PA (US); John THOMAS, Pittsburgh, PA (US)

(21) Appl. No.: 16/365,723

(22) Filed: Mar. 27, 2019

Related U.S. Application Data
(60) Provisional application No. 62/648,758, filed on Mar. 27, 2018.

(51) Int. Cl. A01G 31/06; A01G 7/04; A01G 27/02; A01G 27/00

(52) U.S. Cl. CPC A01G 31/06; A01G 27/008; A01G 27/02; A01G 7/045

(57) ABSTRACT

An indoor system and process for cultivating, harvesting, and outputting a culture of aquatic plants, namely duckweed, are provided. The system includes a water treatment system and cultivation and harvesting system. The water treatment system provides for mixing of nutrients and treated water to form a treatment mixture which is supplied to the cultivation and harvesting system for facilitating growth of the duckweed.

### BACKGROUND OF THE INVENTION

The present invention relates generally to the cultivation and processing of small aquatic photosynthetic organisms such as algae, aquatic species, and the like, including the small aquatic plant floating aquatic species such as duckweeds.

Lemnaceae is a family of flowering plants, also known as the duckweed family, as it contains the duckweeds or water lentils. Duckweeds include the genera Spirodela, Landoltia, Lemna, Wolffia, and Wolfiella. Duckweeds are fast-growing and high-pigment-containing monocotyledonous plants and are classified as macrophytes. Recently, some companies have begun analyzing the nutritional value of duckweeds for human consumption, and have found that due to its amino acid composition, duckweed qualifies as a high quality protein source for human nutrition.

Therefore, it is desirable to provide a system and process for quick, simple and efficient growth and harvesting of duckweed in a reliable manner.

Conventional duckweed growth and harvesting systems and methods are typically implemented in an outdoor setting. As such, the duckweed is exposed to the surrounding environment and subject to contamination, such as bacteria, from the surrounding environment. Consequently, conventional duckweed growth and harvesting systems typically require a decontamination step before the harvested duckweed is suitable for human or animal consumption. In addition, operation of conventional outdoor duckweed growth and harvesting systems are subject to constraints associated with the seasons and weather.

Therefore, it would also be desirable to provide a system and process for growth and harvesting of duckweed that is not impacted by the outdoor environment and the associated seasons and weather.

### BRIEF SUMMARY OF THE INVENTION

In one embodiment, the present invention relates to a system and process for cultivating, harvesting, and outputting a culture of aquatic plants, namely duckweed. The system comprises a water treatment system and cultivation and harvesting system. The water treatment system provides for mixing of nutrients and treated water to form a treatment mixture which is supplied to the cultivation and harvesting system for facilitating growth of the duckweed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings an embodiment which is presently preferred. It should be understood, however, that the invention is not limited to the precise arrangements and instrumentalities shown.

In the drawings:

FIG. 1 is a schematic diagram illustrating a process for producing a treatment mixture in accordance with an embodiment of the present invention;

FIG. 2 is a top view schematic diagram of a cultivation and harvesting system and process in accordance with an embodiment of the present invention;

FIG. 3 is a side view schematic diagram of a growing unit in accordance with an embodiment of the present invention;

FIG. 4 is a top view schematic diagram of the flow surrounding and within a growing vessel according in accordance with an embodiment of the present invention;

FIG. 5 is a perspective view of a portion of a growing unit in accordance with an embodiment of the present invention;

FIG. 6 is top perspective view of a growing vessel in accordance with an embodiment of the present invention;

FIG. 7 is a side view schematic diagram of a harvesting system and process according to the embodiment shown in FIG. 5;

FIG. 8 is a side view schematic diagram of a harvesting system and process according to the embodiment shown in FIG. 6;

FIG. 9 is a top view schematic diagram of a portion of a harvesting system and process in accordance with an embodiment of the present invention;

FIG. 10 is a side view schematic diagram of a portion of a harvesting system and process in accordance with an embodiment of the present invention;

FIG. 11 is a schematic diagram of a portion of a harvesting system and process in accordance with an embodiment of the present invention; and

FIG. 12 is a side perspective view of a cultivation and harvesting system in accordance with another embodiment of the present invention.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the system and designated parts thereof. Unless specifically set forth herein, the terms “a”, “an” and “the” are not limited to one element but instead should be read as meaning “at least one”. The terminology includes the words noted above, derivatives thereof and words of similar import.

As used herein the term “aquatic organism” includes all biological organisms living or growing in, on, or near the water such as, but not limited to, fish, molluscs, crustaceans, echinoderms, other invertebrates and their lifestages, as well as aquatic (e.g., marine and fresh water) plants. Types of aquatic plants include, but are not limited to, a plant from the Lemnaceae family (Duckweed), especially, from the Spirodela, Landoltia, Lemna, Wolffiella and Wolffia genera, edible micro and macro-algae. While embodiments described herein may refer to “aquatic plants,” “an aquatic plant culture,” or “culture of aquatic plants” or to duckweed in particular, any of the embodiments descried herein may be used to grow, culture, harvest, etc. any type of “aquatic organism.” Preferably, however, the system of the present invention is used to grow, culture and harvest duckweed.

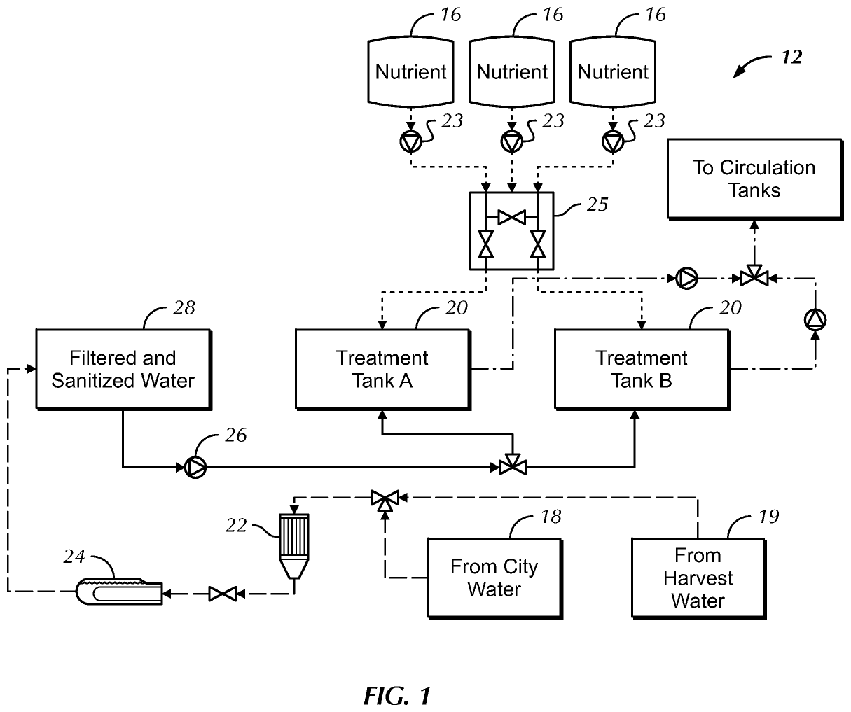

Referring to FIGS. 1-12, there are shown a system and process for cultivating, harvesting, and outputting a culture of aquatic plants, namely duckweed, according to embodiments of the present invention. The system preferably comprises a water treatment system 12 and cultivation and harvesting system 14. The water treatment system 12 provides for mixing of nutrients and treated water to form a treatment mixture which is supplied to the cultivation and harvesting system 14 for facilitating growth of the duckweed.

The water treatment system 12 comprises at least one nutrient tank or container 16, and more preferably a plurality of nutrient tanks 16; a water supply source 18; and at least one treatment tank or container 20, and more preferably a plurality of treatment tanks 20.

Each nutrient tank 16 comprises at least one nutrient, and more preferably, a mixture of organic nutrients and/or inorganic nutrients. The nutrients facilitate rapid vegetative growth of the duckweed. Examples of some nutrients include, but are not limited to, nitrogen (N), phosphorus (P), potassium (K), sulfur (S), calcium (Ca), iron (Fe), magnesium (Mg), boron (B), manganese (Mn), copper (Cu), zinc (Zn), and molybdenum (Mo). For example, the nutrient mixture may be a commercially available mixture, such as General Hydroponics®, MaxiGro™. According to the manufacturer, this solution contains (% by weight) 1.5% Ammoniacal N; 8.5% Nitrate N; 5% Available Phosphate P₂O₅; 14% Soluble Potassium K₂O; 6% Calcium Ca; 2% Soluble Magnesium Mg; 3% Combined Sulfur S; 0.12% Chelated Iron Fe; 0.05% Chelated Manganese Mn; and 0.002% Molybdenum Mo.

Another known nutrient mixture comprises 210 ppm Nitrogen N; 235 ppm Potassium K; 200 ppm Calcium Ca; 31 ppm Phosphorus P; 64 ppm Sulfur S; 48 ppm Magnesium Mg; 0.5 ppm Boron B; 2.5 ppm Iron Fe; 0.5 ppm Manganese Mn; 0.05 ppm Zinc Zn; 0.02 ppm Copper Cu; and 0.01 ppm Molybdenum Mo.

Preferably, where a solid nutrient mixture is used, the mixture is solubilized in filtered and sanitized water to create a liquid concentrate, and the liquid concentrate nutrient mixture is then dosed into the treatment tanks 20 at a predetermined dilution. It will be understood by those skilled in the art that any appropriate dilution level may be utilized, depending upon a variety of factors, such as the composition of the solid nutrient mixture, the desired growth rate of the duckweed, and the like.

Preferably, in the aforementioned nutrient mixtures, the amount of ammoniacal nitrogen is increased and the amount of nitrate nitrogen is decreased, because ammoniacal nitrogen is a preferred nitrogen source by duckweed species. Such an adjustment may be made through the addition of ammonium sulfate and adjustment of the other nutrient concentrations.

It will be understood by those skilled in the art that any nutrient or mixture of nutrients (organic and/or inorganic) suitable for duckweed growth may be utilized in the present system and method, and more particularly stored in the nutrient tanks 16.

In one embodiment, the nutrient tanks 16 are preferably equipped with sensors to monitor one or more factors, such as, but not limited to, nutrient water level, pH, Temperature, Total Dissolved Solids (TDS), Ammonia (NH₄⁺), Nitrate (NO₃⁻). For preparation of the treatment mixture, the nutrients are pumped (e.g., by dosing pumps 23 in FIG. 1) from the nutrient tanks 16 via a valve manifold system 25 to the treatment tanks 20, where the concentrated nutrient solution is introduced into the filtered and sanitized water. The pump rate of the dosing pumps 23 may depend upon a variety of factors, including the size of the tank to be supplied.

The water source 18 is preferably ground water or surface water, such as city or tap water, or water from an industrial plant with which the water treatment system 12 is being operated in tandem (as described in more detail hereinafter). Another source 19 of water for the water treatment system 12 is water which is recycled from the cultivation and harvesting system 14, as will be described in greater detail herein. The ground water 18 and recycled water 19 combine to form a stream of untreated water, as represented by a dashed line in FIG. 1. In the water treatment system 12, the untreated water first passes through a filter 22 and subsequently through a sanitizer 24, to form a stream of treated water.

The filter 22 is preferably used in combination with a UV sanitizer 24 to remove unwanted materials and chemicals from the city make-up water 18 and the recycled harvest water 19. In one embodiment, the filter 22 is a carbon filter having a pore size of 5-10 microns and is configured to remove chemicals such as, but not limited to, chlorine, benzene, radon, various solvents, volatile organic chemicals such as pesticides and herbicides, iron, hydrogen sulfides, lead and the like from the two water sources 18, 19. However, it will be understood that the filter pore size may vary and be selected based on a variety of factors, such as the type of chemical to be removed from the water.

The filtered water is then pumped through the UV sanitizer 24. The UV sanitizer 24 kills micro-organisms, such as bacteria, viruses, molds, and other pathogens that may be present in the filtered water. The UV sanitizer 24 preferably utilizes germicidal fluorescent lamps at a wavelength of 250-270 nanometers (nm) to eradicate the organisms. The water flows through a tube that is surrounded with light from the germicidal fluorescent lamps, preferably at a flow rate of less than 40 gallons per minute (gpm). It will be understood by those skilled in the art that the type and operating conditions of the UV sanitizer, as well as the flow rate of the water to be treated, may vary and be selected based on a variety of factors, such as the type of organisms to be removed from the water.

The water treatment system 12 preferably includes a storage tank 28 for storing the treated water, and more particularly the filtered and sanitized water, until it is needed for preparation of the treatment mixture.

In one embodiment, the water treatment system 12 is operated in tandem with any industrial plant, such that any/or all emissions from the industrial plant can be conditioned and routed to the water treatment systems 12 for producing the treatment mixture, thereby resulting in a close to zero emissions process for the industrial plant.

For preparation of the treatment mixture, the treated water is pumped (for example, via a pump 26) from the storage tank 28 to the treatment tanks 20 at a predetermined flow rate, where it combines with the nutrients supplied from the nutrient tanks 16, in order to form the treatment mixture. The treatment mixture is then pumped (for example, via respective pumps 25) from the treatment tanks 20 to the cultivation and harvesting system 14.

The treatment tanks 20 are preferably maintained at a temperature between 60° F. and 90° F., and more preferably at a temperature of 75° F. It will be understood that the temperature of the treatment tanks 20 may be set to any appropriate temperate as needed for the system 12, for example, based on the composition of the treatment mixture stored therein. The treatment tanks 20 are preferably filled with the filtered and sanitized water and dosed with the concentrated nutrient solution until the treatment mixture is at a prescribed dilution. Periodically, as needed, the treatment tanks 20 are preferably replenished with the filtered and sanitized water, and then adjusted to the correct nutrient dilution by dosing with the concentrated nutrient solution.

In one embodiment, the treatment mixture is preferably enriched with carbon dioxide and/or oxygen for adjustment to and maintenance of the desired pH of the treatment mixture. The pH of the treatment mixture is preferably continuously monitored. More preferably, the pH of the treatment mixture is adjusted to and maintained at a pH suitable for growth of the duckweed into a biomass. Preferably, the pH of the treatment mixture is adjusted to and maintained at a pH of from approximately 4.5 to approximately 8. More preferably, the pH of the treatment mixture is adjusted to and maintained at a pH of 5.5 to 6.5. Adjustment of the pH is preferably carried out within the treatment tanks 20, prior to the treatment mixture being transferred to the cultivation and harvesting system 14.

In one embodiment, each of the inlet and outlet conduits of the water treatment system 12 is equipped with one or more valves, in order to enable accurate control of the water and nutrient flow throughout the water treatment system 12. It will also be understood that any such valves and the pumps of the water treatment system 12 may be manually operated or may be under automated control responsive to the output of one or more sensors provided throughout the water treatment system 12 and/or the cultivation and harvesting system 14.

The cultivation and harvesting system 14 is preferably a completely enclosed system, meaning that it is housed in an indoor facility. As such, operation of the system 14 is not constrained by the seasons and weather. Also, the duckweed to be cultivated by the system 14 is not subject to contamination from the outdoor environment.

The cultivation and harvesting system 14 comprises at least one growing system 30, and more preferably a plurality of growing systems 30. The growing systems 30 are preferably isolated from each other, such that the operation of one system 30 does not affect that of another system 30. The plurality of growing systems 30 may be housed together in a single indoor facility, or separately from each other in multiple indoor facilities.

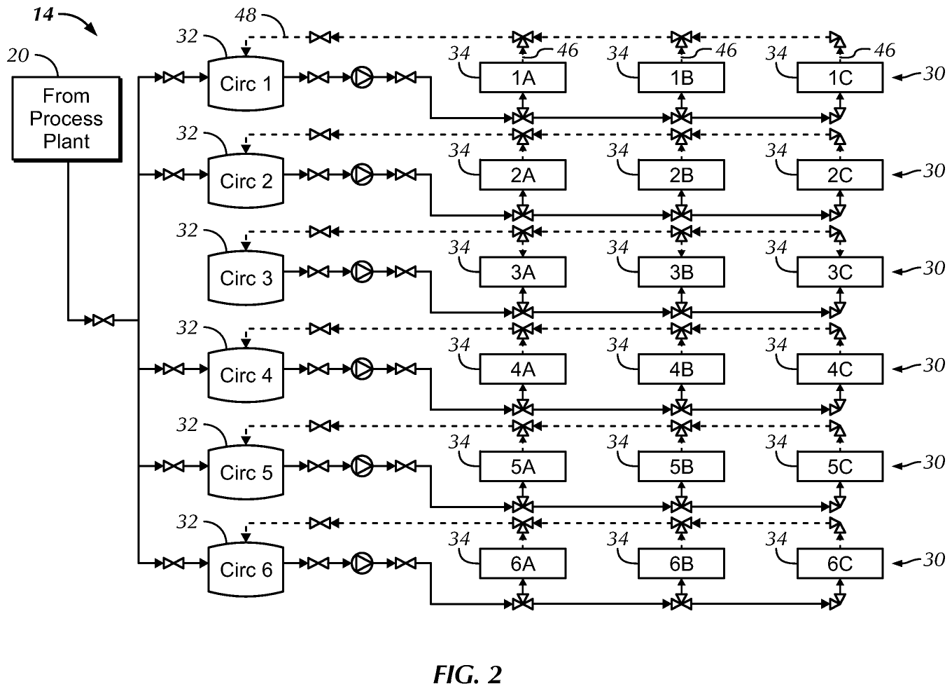

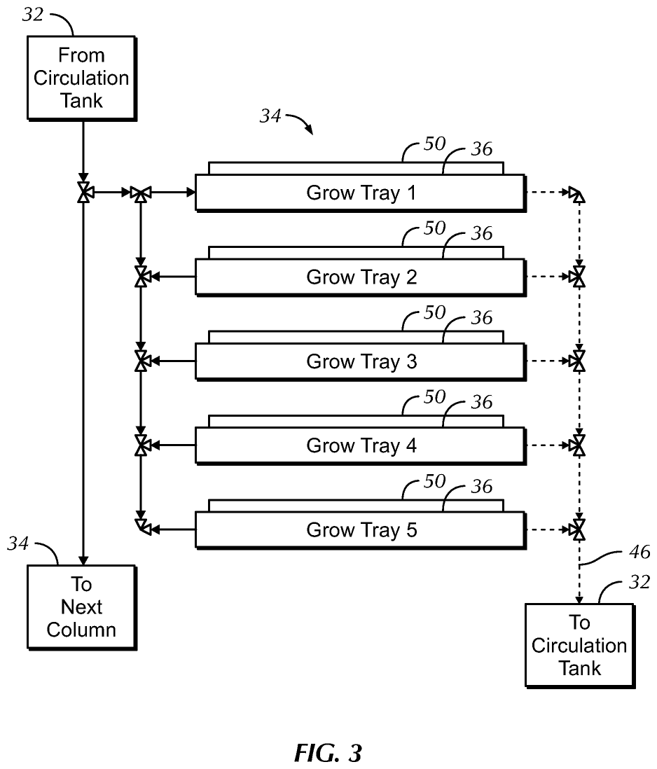

Referring to FIGS. 2-3, each growing system 30 includes a supply tank 32 and a plurality of growing units 34. Each supply tank 32 receives and stores the treatment mixture supplied from the treatment tanks 20 of the water treatment system 12. The supply tanks 32 are preferably maintained at a temperature between 60° F. and 90° F., and more preferably at a temperature of 75° F. It will be understood that the temperature of the supply tanks 32 may be set to any appropriate temperate as needed for the system 14, for example, based on the composition of the treatment mixture stored therein. The supply tanks 32 are preferably maintained at a pH of 4.5 to 8, and more preferably from 5.5 to 6.5. An ammonia (NH₄⁺) concentration within each supply tank 32 is preferably above 2 ppm. A Total Dissolved Solids (TDS) concentration of the contents of each supply tank 32 is preferably below 2,000 ppm. Once the ammonia (NH₄⁺) level drops below the prescribed concentration (2 ppm), the supply tanks 32 are preferably emptied to allow for replenishment from the treatment tanks 20. The drained supply tank treatment mixture is then filtered and sanitized for reuse. Once the TDS levels have surpassed the prescribed concentration (2,000 ppm), the supply tanks 32 and the growing units 34 are preferably drained to allow for refilling of the treatment mixture from the treatment tanks 20.

The growing units 34 of each growing system 30 are arranged adjacent to each other in a side-by-side configuration. Each growing unit 34 comprises a plurality of growing vessels 36 adapted to grow the duckweed. It will be understood that while the term vessel is used herein, any structure which can serve to contain a fluid mixture can be used as the growing vessel 36. The growing vessels 36 are arranged in a vertically-stacked and spaced-apart orientation, as shown in FIG. 3. Thus, the cultivation and harvesting system 14 has a modular and multi-tiered design which optimizes the square footage of the overall growing area.

The number of growing vessels 36 included in each growing system 30 is variable dependent upon the particular size of the growing system 30.

In a preferred embodiment, each growing vessel 36 has a generally rectangular shape formed by four sidewalls, with an open upper end and an opposing closed bottom end 66. Each growing vessel 36 preferably has a length of 15 to 45 feet, a width 5 to 15 feet, and a depth of 0.125 to 1 foot, and more preferably a length of 25 to 35 feet, a width of 7.5 to 10 feet, and a depth of 0.25 to 0.5 feet. The growing vessels 36 are preferably maintained at a pH of 4.5 to 8, and more preferably from 5.5 to 6.5. An ammonia (NH₄⁺) concentration within each growing vessel 36 is preferably above 2 ppm. A Total Dissolved Solids (TDS) concentration of the contents of each growing vessel is preferably below 2,000 ppm. However, it will be understood by those skilled in the art that the size and shape of the growing vessels 36 may vary in particular applications, depending upon the particular needs of the facility.

Each growing vessel 36 preferably has a water level ranging from 0.25 to 1 foot, and more preferably a water level of 2 to 3 inches.

It will be understood by those skilled in the art that the operating conditions of the growing vessels 36, treatment tanks 20 and supply tanks 32 (for example, the pH, the ammonia (NH₄⁺) concentration, the TDS concentration, and the water level) may vary and be set to any value as necessary for achieving optimal conditions for the desired duckweed cultivation rate.

The treatment mixture in the supply tanks 32 and growing vessels 36 is preferably in a constant circulation, and therefore will have the same water quality conditions.

The duckweed is preferably introduced into each of the growing vessels 36 through the open end or through an opening in one of the sidewalls. Preferably, the ratio of the weight of duckweed to the area of each growing vessel 36 ranges from 0.25 ounces of duckweed per 1 ft² growing area to 1 ounce of duckweed per 1 ft² growing area. Such a ratio facilitates rapid vegetative growth of the duckweed, but it will be understood that the ratio may be adjusted (i.e., increased or decreased) as necessary based on process refinement.

Preferably, CO₂ is introduced into the growing vessels 36 and/or into the supply tanks 32 that pump the treatment mixture to the growing vessels 36.

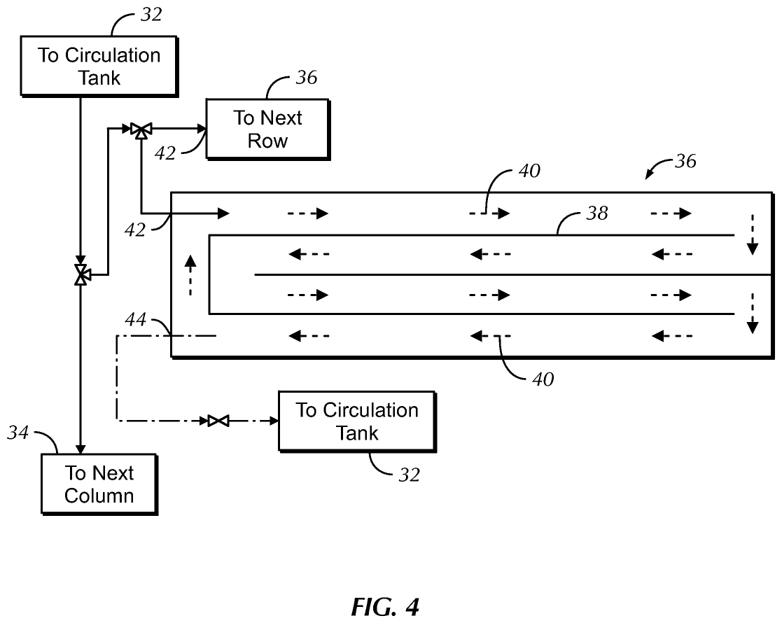

Referring to FIG. 4, each growing vessel 36 includes one or more interior dividing walls 38 that form a meandering channel 40 that provides a continuous circuit flow system used for mixing the treatment mixture and the aquatic organism (i.e., duckweed). More particularly, the meandering channel 40 extends from a treatment mixture inlet 42 to an outlet 44 of each growing vessel 36. The treatment mixture stored in the respective supply tank 32 of each growing system 30 is supplied to the inlet 42 of each growing vessel 36 of each growing unit 34 and circulates through the meandering channel 40 for facilitating growth of the aquatic plant. From the inlet 42, the treatment mixture mixes with the duckweed contained in the growing vessel 36 as it travels through the meandering channel 40 toward the outlet 44.

The treatment mixture is pumped into the growing vessel through the inlet 42 at a flow rate of 100 to 500 gallons per hour (gph), and more preferably 250 to 350 gph. It will be understood by those skilled in the art that the flow rate may vary in particular applications, depending upon the particular needs of the facility and the characteristics of the particular aquatic plant being cultivated. In one embodiment, circulation of the treatment mixture within the meandering channel 40 is generated merely by the force with which the treatment mixture is pumped into the growing vessel 36. In another embodiment, a stirring mechanism (not shown) is used to facilitate the circulation of the treatment mixture through the meandering channel 40.

The treatment mixture is preferably circulated throughout each growing vessel 36 in a closed loop system. During circulation within the meandering channel 40, a portion of the treatment mixture exits a first growing vessel 36 via the outlet 44, and is combined with the exiting treatment mixture of a second growing vessel 36 which is positioned immediately above and/or below the first growing vessel 36, thereby forming a combined recirculation stream 46 for each growing unit 34 in a common conduit (see FIG. 3). The combined recirculation stream 46 of each growing unit 34 is routed to the respective supply tank 32. More particularly, such a combined recirculation stream 46 is generated for each growing unit 34 of each growing system 30, and each of the individual combined recirculation streams 46 combine with each other upstream of the supply tank 32 in a common conduit, so as to form a single recirculation stream 48 which is introduced into the supply tank 32 (see FIG. 2).

Preferably, there is a constant flow of treatment mixture from the respective supply tank 32 to the growing vessels 36, as well as a constant flow of treatment mixture from the growing vessels 36 back to the respective supply tank 32. The rates of both flows are preferably equal going into and exiting out of the growing vessels 36, such that the water column within each growing vessel 36 is maintained at the desired level (for example, 2 to 3 inches).

By the continuous and closed loop recirculation of the treatment mixture to the duckweed through the meandering channel 40, a continuous and rapid growth mode is achieved in each growing system 30.

Also, each growing vessel 36 is provided with a respective overhead light source 50 which promotes growth of the aquatic plant contained therein. The light emitted by the overhead light source 50 is preferably in the visible spectrum of approximately 400 nanometers (nm) to approximately 600 nm. The overhead light source 50 also preferably has a color temperature of 6500 Kelvin (K) to mimic natural sunlight. The overhead light source 50 is positioned at a distance of from 3 inches to 6 feet, and preferably 1 to 2 feet, away from, and more particularly above, the top of the water column inside each growing vessel 36. During a growth cycle, the overhead light sources 50 are preferably operated on a prescribed cycle of periodic on and off periods, such as 18 hours ON, and then 6 hours OFF. This cycle is preferably constantly repeated to create a day and night cycle in order to facilitate rapid vegetative growth of the duckweed.

It will be understood by those skilled in the art that the necessary light intensity and spectrum, the positioning of the light source, and/or the operating durations and cycle of the light source may vary based on a variety of factors, such as the particular duckweed species utilized and the desired growth/cultivation rate.

The cultivation or growth phase of the process is continued until a desired quantity of mature duckweed specimens are produced, that is until a sufficient quantity of a duckweed-based biomass, is produced. Cultivation/growth times are determined empirically and vary, depending on numerous factors within the control of the operator including, for example, the identity of the duckweed species, the composition of the treatment mixture, the pH of the treatment mixture, the temperature of the treatment mixture, and the light intensity for each growing vessel 36. Preferably, the ratio of the weight of duckweed to the area of each growing area 36 ranges from 0.25 ounces of duckweed per 1 ft² growing area to 1 ounce of duckweed per 1 ft² growing area. Once the preferred ratio is reached, the duckweed is harvested (e.g., once daily, bi-daily, or semi-daily basis, or based on an as-needed basis).

As the biomass grows, it develops into a floating mass on the surface of the water contained in each growing vessel 36. The biomass of duckweed is ready for harvesting when the aforementioned preferred ratio of the duckweed weight to growing area is achieved, and more preferably surpassed. Attainment of the ratio may be determined through visual sensor technology, visual observation by those skilled in the art, calculation time periods based on growth, and the like, or a combination of such methods.

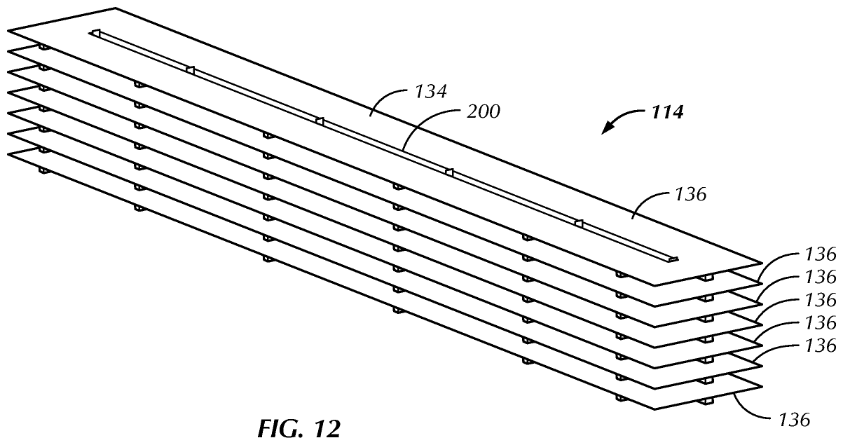

Referring to FIG. 12, there is shown an alternative embodiment of the cultivation and harvesting system 114. The system 114 of FIG. 12 is also preferably a completely enclosed system, meaning that it is housed in an indoor facility. However, instead of a plurality of growing units 34 arranged adjacent to each other in a side-by-side configuration, there is one growing unit 134 which comprises a plurality of growing vessels 136 adapted to grow the duckweed. The growing vessels 136 are arranged in a vertically-stacked and spaced-apart orientation. Each growing vessel 136 is of much larger dimensions that than growing vessels 36 of the first embodiment.

Preferably, each growing vessel 136 has a generally rectangular shape formed by four sidewalls, with an open upper end and an opposing closed bottom end. Each growing vessel 136 preferably has a width of up to 20 feet and a depth of 1 inch to 1 foot, and preferably a depth of between 2 inches to 4 inches. Each growing vessel 136 also preferably has a water level of 2 to 3 inches. This design creates a continuous closed loop circuitous stream of the treatment mixture. By the continuous and closed loop recirculation of the treatment mixture to the duckweed through the design of this embodiment, a continuous and rapid growth mode is achieved in each growing vessel 136 around the central opening 200. The central opening 200 is provided for engagement with a support frame (not shown), plumbing components (not shown), and electrical components (not shown).

It will be understood by those skilled in the art that the length of each growing vessel may be set to any desired size based on a variety of factors, such as the dimensions of the building in which the system is housed. The depth and width of each growing vessel and the water column may also vary based on a based on a variety of factors, such as the dimensions of the building in which the system is housed, the desired cultivation/growth rate, and the like.

The duckweed is preferably introduced into each of the growing vessels 136 through the open end. Preferably, the ratio of the weight of duckweed to the growing vessel 136 area ranges from 0.25 ounces of duckweed per 1 ft² growing area to 1 ounce of duckweed per 1 ft² growing area, although this ratio may be adjusted based on process optimization.

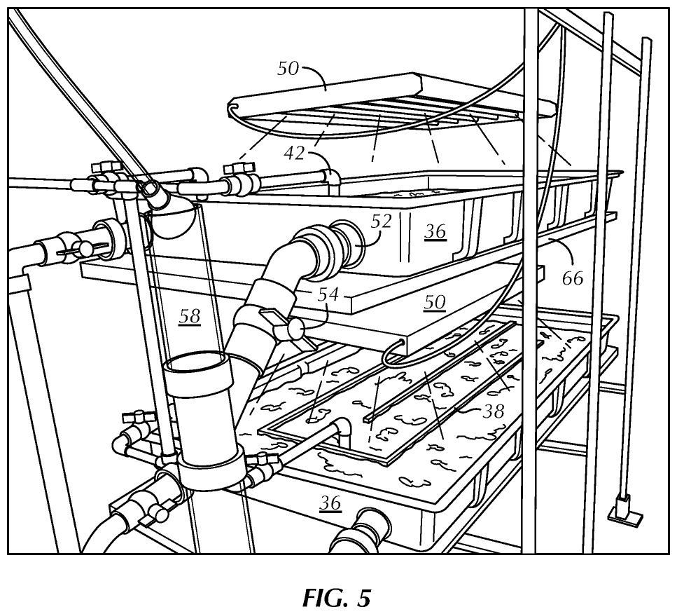

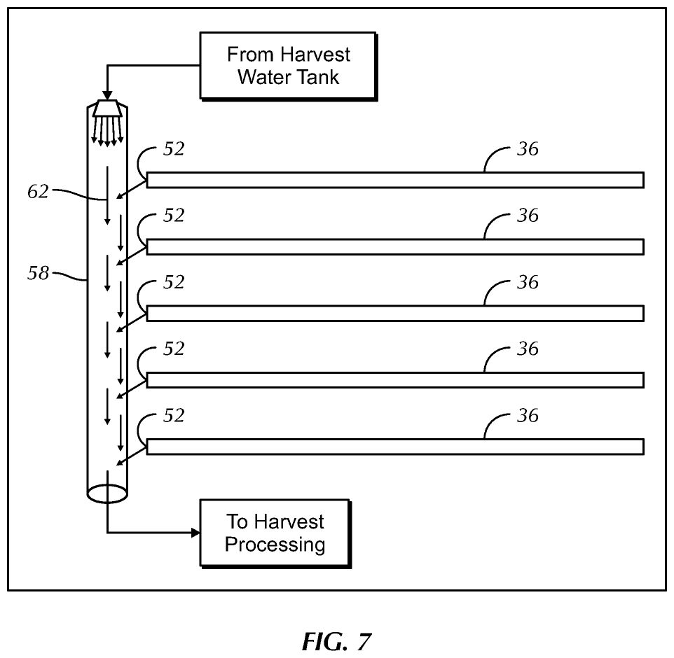

Harvesting of the cultivated duckweed can be done in a variety of manners. In one embodiment, as shown in FIGS. 5 and 7, a sidewall of each growing vessel 36 includes a second outlet conduit 52, hereinafter referred to a harvest outlet. The harvest outlet 52 is provided at a position corresponding to the water surface level of the growing vessel 36, such that the harvest outlet 52 is generally aligned with the floating duckweed on the surface of the water contained in each growing vessel 36. The harvest outlet 52 is preferably equipped with a valve 54, and more particularly a gate valve, which can be selectively opened or closed to enable or prevent flow through the harvest outlet 52. When the gate valve 54 is open, the cultivated duckweed at the surface of the growing vessel 36 and a portion of the water contained in the growing vessel 36, hereinafter referred to as a harvested duckweed mixture, naturally (e.g., by gravity) exits the growing vessel 36 and flows through the harvest outlet 52, and subsequently to a tank 56 for storing harvested duckweed. It will also be understood that a mechanical device may be utilized to facilitate the flow of the cultivated duckweed toward and/or through the harvest outlet 52.

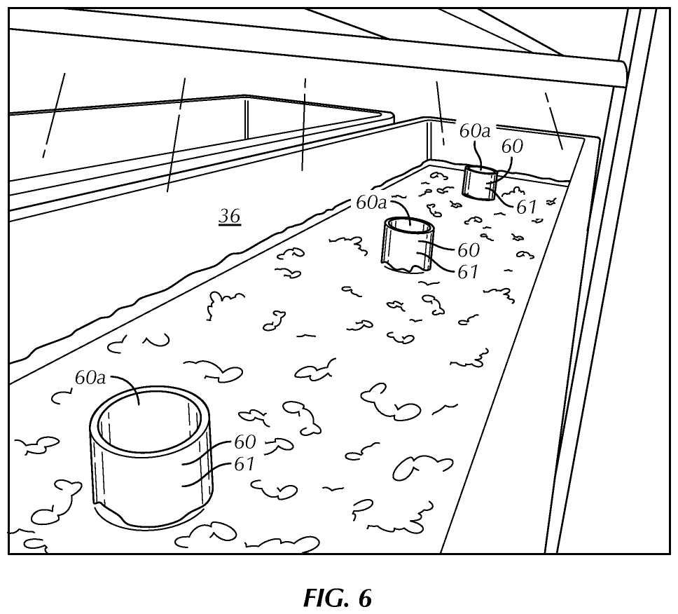

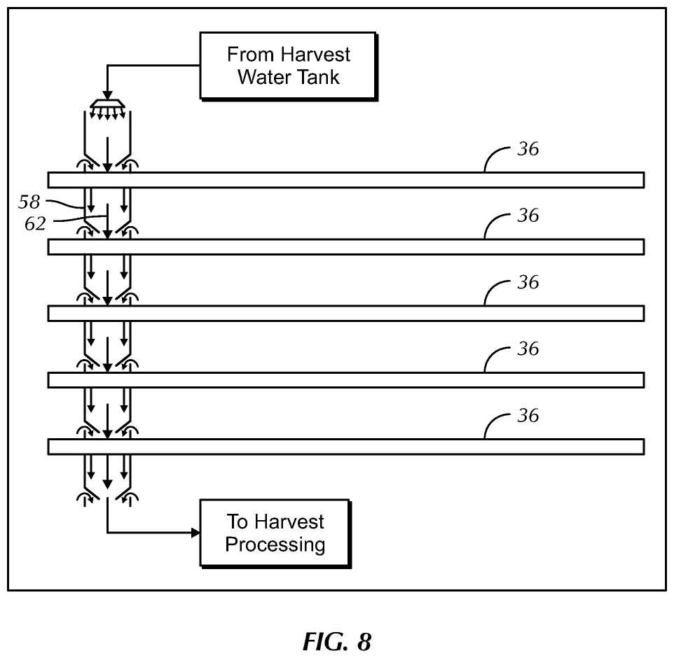

In another embodiment of the harvesting process and system according to the present invention, as shown in FIGS. 6 and 8, each growing vessel 36 is provided with at least one, and preferably a plurality of, conduits or tubes 60 which extend into the interior of each growing vessel 36 and through the bottom wall 66. More particularly, each of the tubes 60, hereinafter referred to as drain tubes 60, has two opposing open ends. A first open end 60a of each drain tube 60 is positioned within the interior of the respective growing vessel 36, above the normal growth water level (i.e., above the surface of the floating mass of duckweed). The opposing second open end (not shown) of each drain tube 60 is positioned outside of the respective growing vessel 36, with the tubular sidewall 61 of each drain tube 60 extending through the bottom wall 66 of the growing vessel 36. In order to harvest the cultivated duckweed from each growing vessel 36, each growing vessel 36 is flooded with water, for example at a rate of 100 to 500 gallons per hour (gph), and more preferably 250 to 350 gph, such that the water level in the growing vessel 36 is caused to rise, thereby resulting in the contents of the growing vessel 36 overflowing into the open ends 60a of the drain tubes 60. More particularly, the duckweed at the surface of the water level is caused to overflow from the growing vessel 36 and into the drain tubes 60 via the first open ends 60a.

As the harvested duckweed mixture exits a first growing vessel 36 (either via the harvest outlet 52 or the drain tubes 60), the harvested duckweed mixture of the first growing vessel 36 is combined with the exiting harvested duckweed mixture of a second growing vessel 36 which is positioned immediately above and/or below the first growing vessel 36 within a conduit 58, thereby forming a combined harvested duckweed mixture stream 62 for each growing unit 34 (see FIGS. 7-8). The second open end of each drain tube 60 is preferably tapered to allow the harvested duckweed and harvest water to fall into the tube positioned below, without any of the harvested duckweed and harvest water from falling into the growing vessel 36 positioned below. To facilitate movement and complete capture of all of the harvested duckweed mixture flowing through the conduit 58 (i.e., in the combined harvested duckweed mixture stream 62), a stream of water which is recycled from the harvesting process is provided, preferably continuously, to the conduit 58 at a flow rate of 100 to 500 gallons per hour (gph), and more preferably 250 to 350 gph. It will be understood by those skilled in the art that the water flow rate may vary in particular applications, depending upon the particular needs of the facility and the characteristics of the particular aquatic plant being cultivated.

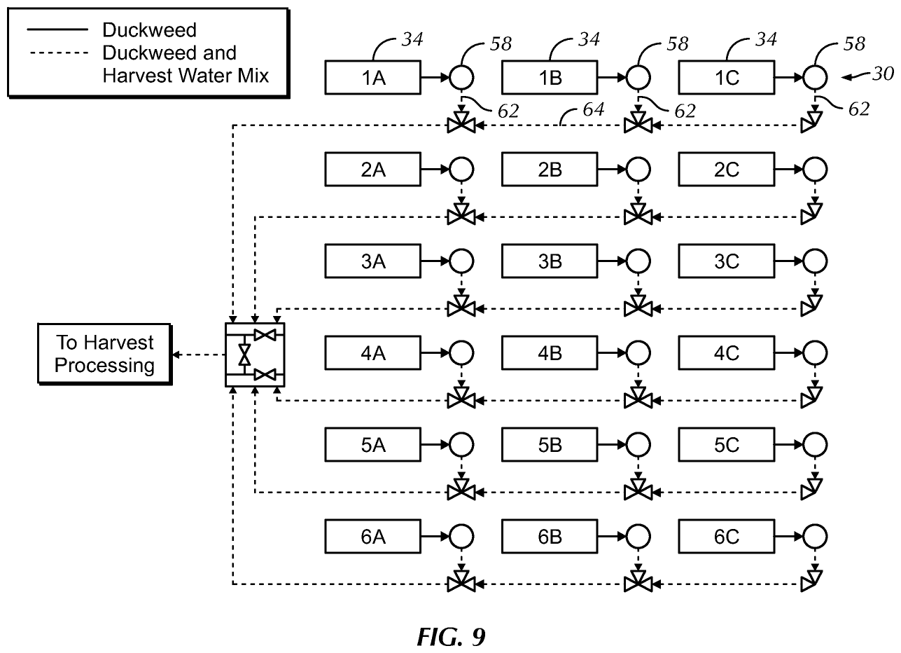

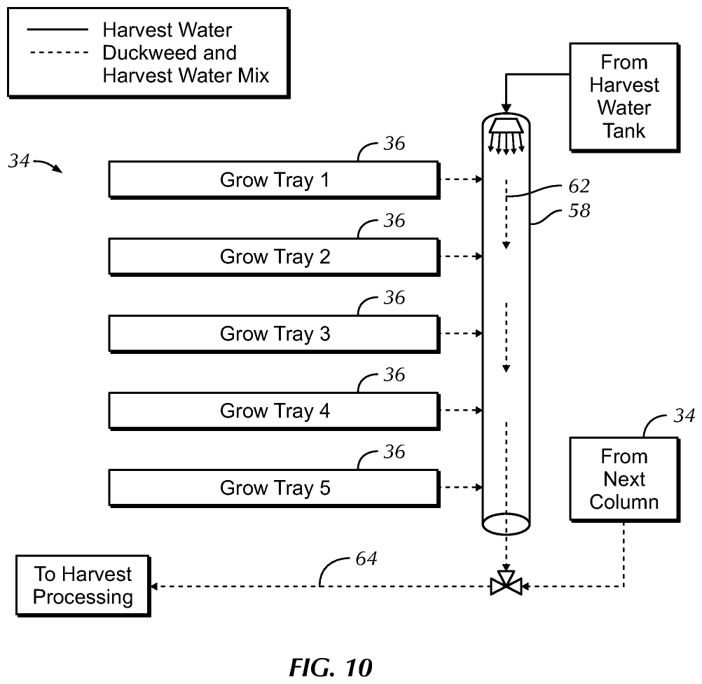

Referring to FIGS. 9-10, the individual combined harvested duckweed mixture streams 62 of each growing unit 34 of each growing system 30 combine with each other upstream of the harvested duckweed mixture storage tank 56, so as to form a single harvested duckweed mixture stream 64 of each growing system 30 which is introduced into the harvested duckweed storage tank 56 (see FIGS. 9-10).

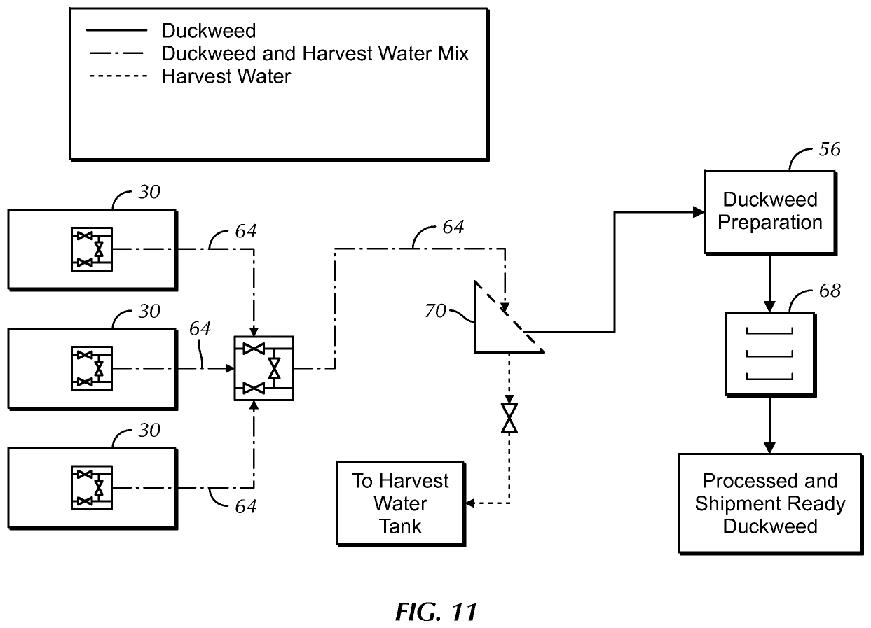

Referring to FIG. 11, the withdrawn aquatic biomass is then subjected to a collection and separation process. Preferably, before being introduced into the harvested duckweed storage tank 56, the harvested duckweed mixture passes through a filtration screen 70 to separate the harvested duckweed from the harvest water. The filtration screen 70 preferably has a mesh size of approximately 1,500 to 3,000 microns (i.e., 1/16 to ⅛ inches). However, it will be understood by those skilled in the art that any appropriate mechanical separation process and/or a filtration screen of any mesh size may be utilized, as long as the solid plant particles are sufficiently separated from residual liquids. For example, the collected biomass may be separated into independent lots via an underwater air distribution system (not shown), or may be passed through a polyphasic separator.

The separated water is recycled to the growing systems 30 during the harvesting process as described above and/or to the water treatment system as described above. The filtered and cultivated duckweed is then stored within the harvested duckweed storage tank 56. Before final processing, in one embodiment, the cultivated duckweed may pass through a dryer 68 for further drying of the duckweed.

Finally, the duckweed is packaged for shipping and use as a protein-based product.

In one embodiment, the duckweed may be washed prior to drying for removal of contaminants. However, because cultivation of the duckweed is carried out in an enclosed setting, a decontamination step is only optional and not necessary.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. An enclosed system for cultivating and harvesting a duckweed-based biomass, the enclosed system comprising:
a water treatment system including at least one nutrient tank containing at least one nutrient, a treated water and at least one treatment tank containing a treatment mixture; and
a cultivation and harvesting system including a plurality of growing vessels configured to receive duckweek and the treatment mixture for cultivating the duckweek-based biomass, each growing vessel including an associated light source and an outlet for harvesting of the cultivated duckweed-based biomass,
wherein the water treatment system provides for mixing of the at least one nutrient and the treated water to form the treatment mixture which is supplied to the cultivation and harvesting system for facilitating growth of the duckweed-based biomass.

2. The enclosed system according to claim 1, wherein the at least one nutrient tank contains a mixture of organic nutrients and inorganic nutrients.

3. The enclosed system according to claim 1, where the at least one nutrient is selected from the group consisting of nitrogen (N), phosphorus (P), potassium (K), sulfur (S), calcium (Ca), iron (Fe), magnesium (Mg), boron (B), manganese (Mn), copper (Cu), zinc (Zn) and molybdenum (Mo).

4. The enclosed system according to claim 1, further comprising a filter and a UV sanitizer, wherein untreated from a water supply source passes through the filter and the UV sanitizer to form the treated water.

5. The enclosed system according to claim 4, wherein the UV sanitizer utilizes germicidal fluorescent lamps at a wavelength of 250-270 nanometers.

6. The enclosed system according to claim 1, wherein the treatment mixture is preferably enriched with at least one of carbon dioxide and oxygen.

7. The enclosed system according to claim 1, wherein the growing vessels are arranged in a vertically-staked and spaced-apart orientation.

8. The enclosed system according to claim 1, wherein each growing vessel has a water level ranging from 0.25 to 1 foot.

9. The enclosed system according to claim 8, wherein the water level in each growing vessel ranges from 2 to 3 inches.

10. The enclosed system according to claim 1, wherein each growing vessel includes an inlet, an outlet and a meandering flow channel extending from the inlet to the outlet, such that the treatment mixture which is supplied to the inlet of each growing vessel mixes with the duckweed as it travels through the meandering flow channel towards the outlet.

11. The enclosed system according to claim 1, wherein the associated light source of each growing vessel is an overhead light source which emits light in the visible spectrum of approximately 400 nanometers to approximately 600 nanometers.

12. The enclosed system according to claim 1, wherein a ratio of the weight of duckweed to a growing area within each growing vessel ranges from 0.25 ounces of duckweed per 1 square foot of growing area to 1 ounce of duckweed per 1 square foot of growing area.

13. A method for cultivating and harvesting a duckweed-based biomass in an enclosed environment, the method comprising:
providing a treatment mixture and duckweed to at least one growing vessel having an associated light source, each growing vessel having an inlet, an outlet and a meandering flow channel extending from the inlet to the outlet, the treatment mixture being supplied to the inlet of each growing vessel and mixing with the duckweed as it travels through the meandering flow channel towards the outlet in a closed loop system to form a duckweed-based biomass until a predetermined ratio of the weight of duckweed to a growing area of the at least one growing vessel is achieved; and
harvesting the duckweed-based biomass from the at least one growing vessel.

14. The method according to claim 13, wherein the treatment mixture includes at least one nutrient selected from the group consisting of nitrogen (N), phosphorus (P), potassium (K), sulfur (S), calcium (Ca), iron (Fe), magnesium (Mg), boron (B), manganese (Mn), copper (Cu), zinc (Zn) and molybdenum (Mo).

15. The method according to claim 13, wherein the predetermined ratio of the weight of duckweed to a growing area within each growing vessel ranges from 0.25 ounces of duckweed per 1 square foot of growing area to 1 ounce of duckweed per 1 square foot of growing area.

16. The method according to claim 13, wherein the at least one growing vessel includes a harvest outlet at a position corresponding to a water level of the at least one growing vessel, the harvest outlet being equipped with a valve, and wherein the harvesting of the duckweed-based biomass is performed by opening the valve to allow the flow of duckweed through the harvest outlet.

17. The according to claim 16, wherein the water level is from 0.25 to 1 foot.

18. The method according to claim 13, wherein the at least one growing vessel includes at least one conduit extending into an interior of the at least one growing vessel through a bottom wall thereof, a first open end of the at least one conduit being positioned above a water level of the at least one growing vessel, and wherein harvesting of the duckweed-based biomass is performed by introducing additional water into the at least one growing vessel until the water level rises and the duckweed-based biomass overflows into the first open end of the at least one conduit.

19. The method according to claim 18, wherein the water level is from 2 to 3 inches.

20. The method according to claim 13, wherein the associated light source is an overhead light source which emits light in the visible spectrum of approximately 400 nanometers to approximately 600 nanometers.
